(19) United States
(12) Patent Application Publication
(10) Pub. No.: US 2013/0290952 A1
(43) Pub. Date: Oct. 31, 2013

(54) Copying Virtual Machine Templates To Cloud Regions

(71) Applicant: Jerry W. Childers, JR., Philadelphia, PA (US)

(72) Inventor: Jerry W. Childers, JR., Philadelphia, PA (US)

(21) Appl. No.: 13/455,892

(22) Filed: Apr. 25, 2012

(51) Int. Cl. G06F 9/455; G06F 15/16

(52) U.S. Cl. 718/1

(57) ABSTRACT

A method includes transmitting a list of virtual machine templates from a cloud management system for display to a user, the list indicating for each virtual machine template a particular region from among plural cloud regions defined as a source region in which the virtual machine template is located. A copy request is received at the cloud management system, indicating one of the virtual machine templates to copy from its associated source region to a selected destination region. The copy request is transmitted to a first cloud control server in the selected source region. The selected template is read from a block storage device in the source region and transmitted to a second cloud control server in the destination region. At the second cloud control server the transmitted template is stored to a destination virtual machine template at a block storage device in the destination region.

### TECHNICAL FIELD

This patent disclosure relates to information technology and in particular to copying virtual machine templates to cloud regions.

### BACKGROUND

The data center model for providing Information Technology (IT) services allows customers to run their business data processing systems and applications from a centralized facility. Solutions include hosting services, application services, e-mail and collaboration services, network services, managed security services, storage services and replication services. These solutions are suited to organizations that require a secure, highly available and redundant environment.

Such data centers can be located on the customer's premises and can be operated by customer employees. However, the users of data processing equipment increasingly find a remotely hosted service model to be the most flexible, easy, and affordable way to access the data center functions and services they need. By moving physical infrastructure and applications to cloud based servers accessible over the Internet or private networks, customers are free to specify equipment that exactly fits their requirements at the outset, while having the option to adjust with changing future needs on a “pay as you go” basis.

This promise of scalability allows expanding and reconfiguring servers and applications as needs grow, without having to spend for unneeded resources in advance. Additional benefits provided by professional level cloud service providers include access to the most up to date equipment and software with superior performance, security features, disaster recovery services, and easy access to information technology consulting services.

Typically, cloud based servers are provided by a service provider in the form of virtual machines (VMs). These VMs are instances of an operating system running within a single physical server (called a host), configured with a certain amount of processing, memory and storage while being isolated from other VMs on the same physical server. Virtual machines are typically represented within the host as a set of files that contain both configuration parameters and represent virtual disks presented to the VM. Software systems used to manage VMs within physical hosts can create a copy of the file-based representation of the VM in order to create new VMs that have the same configuration and data as the original VM. Typically, these copies are called VM templates.

### SUMMARY

In one aspect, a method includes transmitting a list of virtual machine templates from a cloud management system for display to a user, the list indicating for each virtual machine template a particular region from among plural cloud regions defined as a source region in which the virtual machine template is located, with the plural cloud regions being remote from each other and each having virtualization infrastructure therein. A copy request is received at the cloud management system, the copy request indicating one of the virtual machine templates to copy from its associated source region to a selected region among the plural cloud regions defined as a destination region. The copy request is transmitted from the cloud management system to a first cloud control server in the selected source region. At the first cloud control server the selected virtual machine template is read from a block storage device in the selected source region and the read virtual machine template is transmitted to a second cloud control server in the selected destination region. At the second cloud control server the transmitted virtual machine template is stored to a destination virtual machine template at a block storage device in the selected destination region.

In an embodiment, the second cloud control server may communicate to the cloud management system to update the list of virtual machine templates with the destination virtual machine template and its associated region. A measure of storage consumption associated with the user across the plural cloud regions may be updated based on the updated list of virtual machine templates.

In an embodiment, a checksum of the selected virtual machine template may be performed at both the first cloud control server and the second cloud control server, providing the user with verification that the copy operation did not result in corruption of the virtual machine template during the transfer.

The cloud management system may be located in one of the plural cloud regions and may be configured to provide the user with access via at least one of a user website and a network accessible application program interface.

The virtualization infrastructure at each cloud region may include one or more of a physical data processing machine, virtual machine, networking device, switch, router, firewall, storage device, or other data processing function.

The selected virtual machine template may comprise one or more files compatible with a virtual machine definition and storage format. The virtual machine definition and storage format may be, for example, Open Virtualization Format.

In an embodiment, the copy request may indicate one or more selected regions among the plural cloud regions.

In another embodiment, the destination virtual machine template may be registered for use with the virtualization infrastructure in the selected destination region.

In another aspect, a system includes a storage device, a cloud management system, a first cloud control server and a second cloud control server. The storage device is configured to store a list of virtual machine templates, the list indicating for each virtual machine template a particular source region from among plural cloud regions in which the virtual machine template is located, with the plural cloud regions remote from each other and each having virtualization infrastructure therein. The cloud management system is configured to retrieve the list of virtual machine templates from the storage device, transmit the list for display to a user, receive a copy request indicating one of the virtual machine templates to copy from its associated source region to a selected destination region among the plural cloud regions, and transmit the copy request to the selected source region. The first cloud control server is located in the selected source region and is configured to execute a first template service process that receives the copy request transmitted from the cloud management system, reads the selected virtual machine template from a block storage device in the selected source region, and transmits the read virtual machine template to the selected destination region. The second cloud control server is located in the selected destination region and is configured to execute a second template service process that receives the virtual machine template transmitted from the first template service process, stores the received virtual machine template to a destination virtual machine template at a block storage device in the selected destination region, and registers the destination virtual machine template for use with the virtualization infrastructure in the selected destination region.

In another aspect, a method comprises receiving a copy request indicating one of plural virtual machine templates to copy from a selected source region to a selected destination region among plural cloud regions, reading the selected virtual machine template from a block storage device and transmitting the read virtual machine template to the selected destination region.

In yet another aspect, a system comprises a block storage device; a cloud control server in a selected source region among plural cloud regions, the cloud control server configured to (a) receive a copy request indicating one of plural virtual machine templates to copy from the selected source region to a selected destination region among the plural cloud regions; (b) read the selected virtual machine template from the block storage device; and (c) transmit the read virtual machine template to the selected destination region.

In another aspect, a programmable computer system product comprises one or more data processing machines that execute instructions retrieved from a storage media, the instructions for (a) receiving a copy request indicating one of plural virtual machine templates to copy from a selected source region to a selected destination region among plural cloud regions; (b) reading the selected virtual machine template from a block storage device; and (c) transmitting the read virtual machine template to the selected destination region.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a high level diagram of a service provider level data processing environment that includes several cloud regions.

FIG. 2 is a diagram illustrating a process flow across cloud regions.

FIG. 3 is an example screenshot illustrating a listing of virtual machine templates for an example customer.

FIG. 4 illustrates an example screenshot of a user dialog box for selecting a copy to region function.

### DETAILED DESCRIPTION

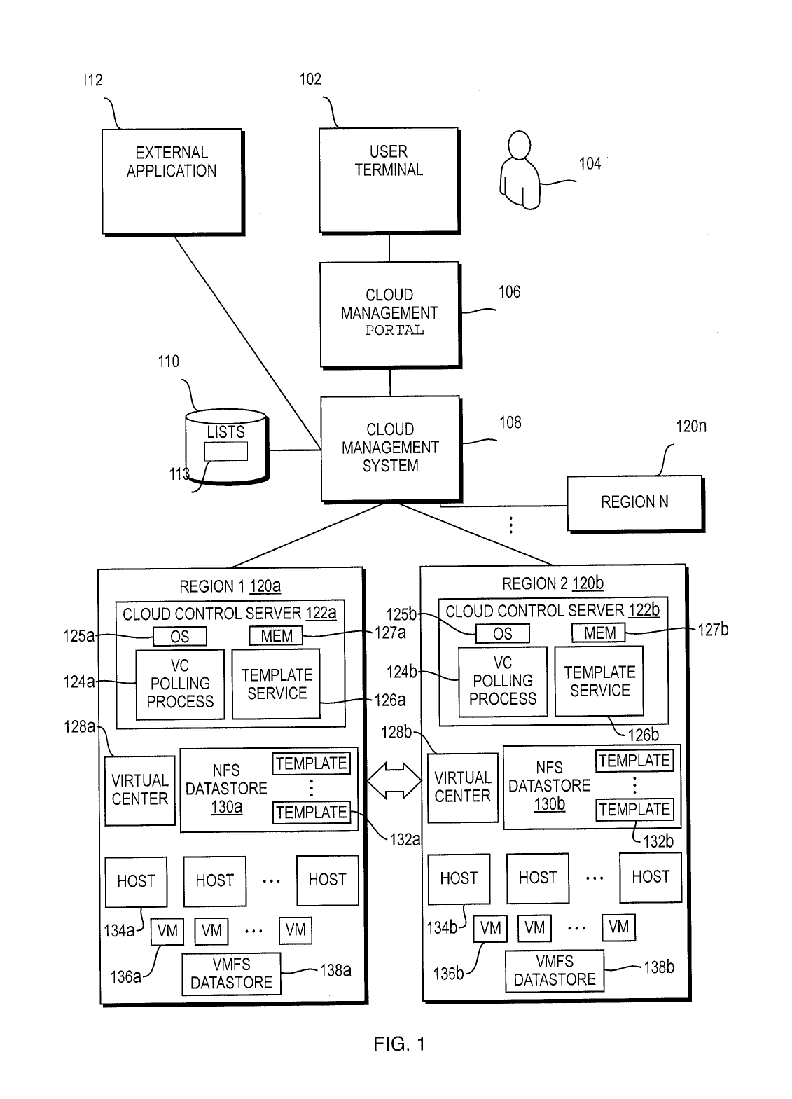

FIG. 1 is a high level diagram of a service provider level data processing environment in which the improved virtual machine replication procedures described herein may used. It should be understood that this is but one example environment and many others are possible.

The illustrated service provider environment includes several data processing regions 120A, 120B, . . . 120N, referred to herein as “cloud regions.”

Cloud based services are often provided out of more than one physical data center location. For many service providers, a cloud region is considered to be either a single physical data center, or a collection of physical data centers located within a certain geographical distance from each other. The geographical boundary is typically based on a defined network latency, e.g., within five milliseconds. The cloud regions may be interconnected through connections to various networks such as private networks and the Internet.

Many cloud providers offer customers the ability to use cloud services in multiple regions. An example of this would be if a cloud provider offered services in Boston and San Francisco, and could provide customers with access to both the Boston and San Francisco cloud regions.

Located in each of the cloud regions 120 may be various infrastructure elements, including, but not limited to, one or more cloud control servers 122, virtual centers 128, network file system (NFS) datastores 130, physical hosts 134, virtual machines 136 and virtual machine file system (VMFS) datastores 138.

The cloud control server 122 includes an operating system 125, memory 127, and various services and processes, including a virtual center polling process 124 and template service 126 described further herein.

The virtual center 128 is a server (e.g., VMware vCenter Server) that manages the virtual machines (VMs) 136 running on the physical hosts 134. Each of the VMs 136 typically includes an operating system and one or more applications and has access to various resources such as virtual memory, disk storage and other resources. The VMFS datastore 138 is a cluster file system that stores virtual machine disk images associated with the VMs 136. The NFS datastore 130 stores virtual machine templates 132 that define particular virtual machines. Other infrastructure elements not shown may include routers, switches, firewalls, load balancers, and so forth.

The service provider may provide a cloud management system 108 to allow each service customer user 104 to interact with and configure certain aspects of the customer's associated infrastructure elements in the cloud regions in a highly automated fashion. The cloud management system 108 may be a server located in any one of the cloud regions and may be configured to provide the user with access via a user website offered through a cloud management portal 106, a network accessible application program interface (API) external application 112, or both.

The cloud management system 108 is connected to a database 110 that stores, among other data, one or more lists or tables 113 of virtual machine templates associated with particular service customers.

An example table definition for the list of virtual machine templates 113 is illustrated in the following table. The datastore_id field links to a datastore, which links to a region table (not shown).

| Field | Type | Null | Key | Default | Extra |
|---|---|---|---|---|---|
| Id | int(11) | NO | PRI | NULL | Auto_increment |
| datastore_id | int(11) | NO | MUL | NULL | |
| customer_id | int(11) | NO | MUL | NULL | |
| name | varchar(50) | NO | | NULL | |
| uuid | varchar(50) | NO | | NULL | |
| size_in_gb | double | NO | | NULL | |
| uncommitted_ size_in_gb | double | NO | | NULL | |
| ram_in_mb | int(11) | NO | | NULL | |
| version | int(11) | NO | | NULL | |
| refresh_time | datetime | YES | | NULL | |
| os | varchar(255) | NO | | NULL | |

The virtual machine templates 132 may comprise one or more files compatible with a virtual machine definition and storage format. An example virtual machine definition and storage format is Open Virtualization Format (OVF). OVF is an industry standard (Version 1.1, published January 2010 by the Distributed Management Task Force) that describes metadata about virtual machine images in Extensible Markup Language (XML) format. The metadata may include, for example, information about the particular operating system and software applications for that virtual machine In OVF, the disk files are stored in a compressed, sparse format. A virtual machine can be created using well-known virtual machine tools and then exported to an OVF package or template having the relevant metadata needed to correctly install and execute it on another host.

For example, a user may have a need for five web servers. By creating one virtual machine as a web server and then exporting the virtual machine to a virtual machine template, the user can simply make four copies of the web server from the template. As described further herein, the improved approach of the present disclosure provides for distributing copies of virtual machine templates created in one cloud region to other cloud regions.

In particular, the improvement in an embodiment allows the service customer user to access the customer's list of virtual machine templates 113 and see which virtual machine templates reside in which cloud regions. For example, the user can select a particular virtual template that is stored in the Boston cloud region and request that a copy of the selected template be sent to the San Francisco cloud region. This approach has several advantages. By sending a copy of the smaller-sized virtual machine template rather than a copy of the actual virtual machine itself, transmission resources are saved. In addition, provisioning of virtual machines is faster. Using the example above, if the user originally provisioned five web servers from the virtual machine template in the Boston cloud region and now needs to provision ten of the same or similar web servers for the San Francisco cloud region, the user need only have a copy of the virtual machine template sent from the Boston cloud region to the San Francisco cloud region. The subsequent provisioning of the ten new web servers from the copy of the virtual machine template now locally stored in the San Francisco cloud region will be much faster than trying to provision a new virtual machine from the original virtual machine located in the Boston cloud region.

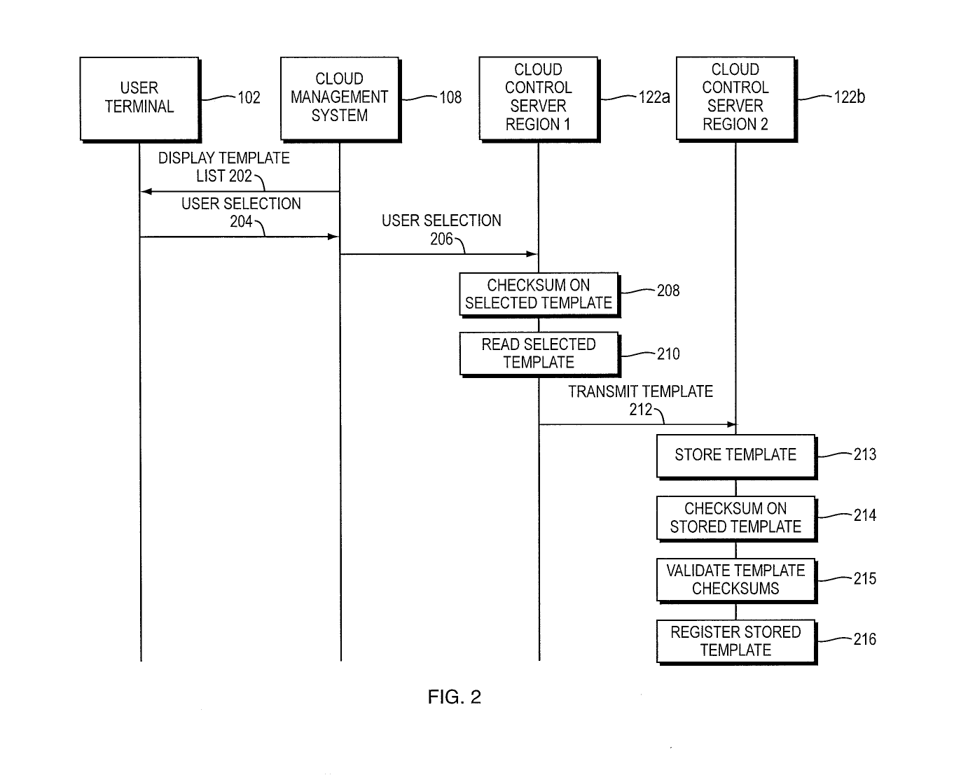

With reference now to FIG. 2, an example process flow is described for an example embodiment.

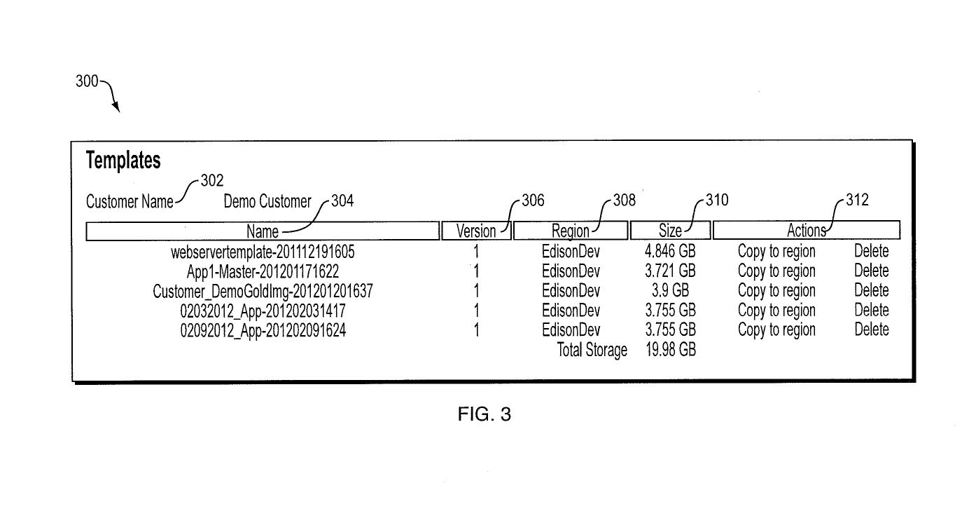

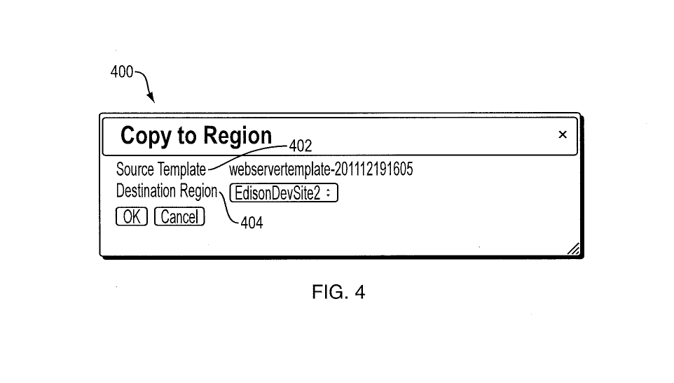

A user at user terminal 102 is presented 202 with a screen through a user interface provided through cloud management portal 106. The screen, shown as an example screenshot in FIG. 3, presents the user with a list of templates 304 for the customer name 302, indicating version 306, region 308, size 310 and possible actions 312 for each listed template. The actions may include “copy to region” and “delete.” If the user selects “copy to region” for a particular template that is on the list, a dialog box pops up on the screen. An example dialog box is shown in FIG. 4. The dialog box indicates the selected source template 402 and a registry of available destination cloud regions 404 to which the source template may be copied. The user may then pick from the available destination cloud regions and click “ok.”

Referring again to FIG. 2, upon making the user selection, for example to copy from cloud region 1 to cloud region 2, the cloud management system 108 receives the user selection 204 and transmits the user selection 206 to the cloud control server in the cloud region that has the selected template stored therein. In this example, the cloud management system 108 communicates with cloud control server 122A in cloud region 1. The template service 126A running on cloud control server 122A receives the request to copy the selected source template from region 1 to region 2. First a checksum is performed on the selected template 132A at 208. The template service 126A communicates through the virtual center 128A to read the files of the selected template 132A from the NFS datastore 130A at 210. Next, the template service 126A operates to transmit the selected template 212 over to the destination region (e.g., region 2). At that point, when the copy operation completes, the transmitted virtual machine template is stored at 213 to a destination virtual machine template 132B at NFS datastore 130B. Corresponding template service 126B at the cloud control server 122B in region 2 performs the same checksum 214 on the stored template and compares it with the checksum performed at cloud control server 122A to verify at 215 that the copy operation did not result in corruption of the template during transfer from region 1 to region 2. The template service 132B then registers 216 the stored template with the virtualization software operated by virtual center 128B in that region, which makes it available for provisioning in region 2.

When that registration event occurs, there is also a process which is shown as the virtual center polling process 124. The virtual center polling process 124 watches the virtual center to look for change events. In this case, the registration of the template that was just copied over is an example of a change event. The polling process 124B recognizes that event has occurred and sends a refresh method call up to the database 110 which says effectively that a new template is now available in region 2.

While the foregoing example has been described for copying a virtual machine template from a source cloud region to one destination cloud region, it should be understood that the copying can be configured to be made from a source cloud region to multiple destination cloud regions.

It should be understood that the example embodiments described above may be implemented in many different ways. In some instances, the various “data processors” described herein may each be implemented by a physical or virtual general purpose computer having a central processor, memory, disk or other mass storage, communication interface(s), input/output (I/O) device(s), and other peripherals. The general purpose computer is transformed into the processor and executes the processes described above, for example, by loading software instructions into the processor, and then causing execution of the instructions to carry out the functions described.

As is known in the art, such a computer may contain a system bus, where a bus is a set of hardware lines used for data transfer among the components of a computer or processing system. The bus or busses are essentially shared conduit(s) that connect different elements of the computer system (e.g., processor, disk storage, memory, input/output ports, network ports, etc.) that enables the transfer of information between the elements. One or more central processor units are attached to the system bus and provide for the execution of computer instructions. Also attached to system bus are typically I/O device interfaces for connecting various input and output devices (e.g., keyboard, mouse, displays, printers, speakers, etc.) to the computer. Network interface(s) allow the computer to connect to various other devices attached to a network. Memory provides volatile storage for computer software instructions and data used to implement an embodiment. Disk or other mass storage provides non-volatile storage for computer software instructions and data used to implement, for example, the various procedures described herein.

Embodiments may therefore typically be implemented in hardware, firmware, software, or any combination thereof.

The computers that execute the processes described above may be deployed in a cloud computing arrangement that makes available one or more physical and/or virtual data processing machines via a convenient, on-demand network access model to a shared pool of configurable computing resources (e.g., networks, servers, storage, applications, and services) that can be rapidly provisioned and released with minimal management effort or service provider interaction. Such cloud computing deployments are relevant and typically preferred as they allow multiple users to access computing resources as part of a shared marketplace. By aggregating demand from multiple users in central locations, cloud computing environments can be built in data centers that use the best and newest technology, located in the sustainable and/or centralized locations and designed to achieve the greatest per-unit efficiency possible.

In certain embodiments, the procedures, devices, and processes described herein are a computer program product, including a computer readable medium (e.g., a removable storage medium such as one or more DVD-ROMs, CD-ROMs, diskettes, tapes, etc.) that provides at least a portion of the software instructions for the system. Such a computer program product can be installed by any suitable software installation procedure, as is well known in the art. In another embodiment, at least a portion of the software instructions may also be downloaded over a cable, communication and/or wireless connection.

Embodiments may also be implemented as instructions stored on a non-transient machine-readable medium, which may be read and executed by one or more procedures. A non-transient machine-readable medium may include any mechanism for storing or transmitting information in a form readable by a machine (e.g., a computing device). For example, a non-transient machine-readable medium may include read only memory (ROM); random access memory (RAM); magnetic disk storage media; optical storage media; flash memory devices; and others.

Furthermore, firmware, software, routines, or instructions may be described herein as performing certain actions and/or functions. However, it should be appreciated that such descriptions contained herein are merely for convenience and that such actions in fact result from computing devices, processors, controllers, or other devices executing the firmware, software, routines, instructions, etc.

It also should be understood that the block and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and thus the computer systems described herein are intended for purposes of illustration only and not as a limitation of the embodiments.

While this invention has been particularly shown and described with references to example embodiments thereof, it will be understood by those skilled in the art that various changes in form and details may be made therein without departing from the scope of the invention encompassed by the appended claims.

What is claimed is:

1. A method comprising:
transmitting a list of virtual machine templates from a cloud management system for display to a user, the list indicating for each virtual machine template a particular region from among plural cloud regions defined as a source region in which the virtual machine template is located, the plural cloud regions remote from each other and each having virtualization infrastructure therein;
receiving a copy request at the cloud management system, the copy request indicating one of the virtual machine templates to copy from its associated source region to a selected region among the plural cloud regions defined as a destination region;
transmitting the copy request from the cloud management system to a first cloud control server in the selected source region;
reading the selected virtual machine template at the first cloud control server from a block storage device in the selected source region;
transmitting the read virtual machine template to a second cloud control server in the selected destination region;
storing the transmitted virtual machine template at the second cloud control server to a destination virtual machine template at a block storage device in the selected destination region.

2. The method of claim 1 further comprising:
communicating from the second cloud control server to the cloud management system to update the list of virtual machine templates with the destination virtual machine template and its associated region.

3. The method of claim 2 further comprising:
updating a measure of storage consumption associated with the user across the plural cloud regions based on the updated list of virtual machine templates.

4. The method of claim 1 further comprising:
performing a first checksum of the selected virtual machine template at the first cloud control server;
performing a second checksum of the transmitted virtual machine template at the second cloud control server;
comparing the first and second checksums to validate the transmitted virtual machine template.

5. The method of claim 1 wherein the cloud management system is located in one of the plural cloud regions and is configured to provide the user with access via at least one of a user website and a network accessible application program interface.

6. The method of claim 1 wherein the virtualization infrastructure at each cloud region includes one or more of a physical data processing machine, virtual machine, networking device, switch, router, firewall, storage device, or other data processing function.

7. The method of claim 1 wherein the selected virtual machine template comprises one or more files compatible with a virtual machine definition and storage format.

8. The method of claim 1 wherein the copy request indicates one or more selected regions among the plural cloud regions.

9. The method of claim 1 further comprising registering the destination virtual machine template for use with the virtualization infrastructure in the selected destination region.

10. A system comprising:
a storage device for storing a list of virtual machine templates, the list indicating for each virtual machine template a particular source region from among plural cloud regions in which the virtual machine template is located, the plural cloud regions remote from each other and each having virtualization infrastructure therein;
a cloud management system configured to retrieve the list of virtual machine templates from the storage device, transmit the list for display to a user, receive a copy request indicating one of the virtual machine templates to copy from its associated source region to a selected destination region among the plural cloud regions, and transmit the copy request to the selected source region;
a first cloud control server in the selected source region, the first cloud control server configured to execute a first template service process that receives the copy request transmitted from the cloud management system, reads the selected virtual machine template from a block storage device in the selected source region, and transmits the read virtual machine template to the selected destination region; and
a second cloud control server in the selected destination region, the second cloud control server configured to execute a second template service process that receives the virtual machine template transmitted from the first template service process, stores the transmitted virtual machine template to a destination virtual machine template at a block storage device in the selected destination region, and registers the destination virtual machine template for use with the virtualization infrastructure in the selected destination region.

11. The system of claim 10 wherein the second cloud control server is further configured to execute a polling process that communicates with the cloud management system to update the list of virtual machine templates with the destination virtual machine template and its associated region.

12. The system of claim 11 wherein the cloud management system is further configured to update a measure of storage consumption associated with the user across the plural cloud regions based on the updated list of virtual machine templates.

13. The system of claim 10 wherein the first template service process performs a checksum of the selected virtual machine template, the second template service process performs a checksum of the received virtual machine template and compares the first and second checksums to validate the received virtual machine template.

14. The system of claim 10 wherein the cloud management system is located in one of the plural cloud regions and is configured to provide the user with access via at least one of a user website and a network accessible application program interface.

15. The system of claim 10 wherein the virtualization infrastructure at each cloud region includes one or more of a physical data processing machine, virtual machine, networking device, switch, router, firewall, storage device, or other data processing function.

16. The system of claim 10 wherein the selected virtual machine template comprises one or more files compatible with a virtual machine definition and storage format.

17. The system of claim 10 wherein the copy request indicates one or more selected regions among the plural cloud regions.

18. The system of claim 10 wherein the second template service process registers the destination virtual machine template for use with the virtualization infrastructure in the selected destination region.

19. A system comprising:
a block storage device;
a cloud control server in a selected source region among plural cloud regions, the cloud control server configured to:
receive a copy request indicating one of plural virtual machine templates to copy from the selected source region to a selected destination region among the plural cloud regions;
read the selected virtual machine template from the block storage device; and
transmit the read virtual machine template to the selected destination region.

20. The system of claim 19 wherein the selected virtual machine template comprises one or more files compatible with a virtual machine definition and storage format.

21. The system of claim 19 wherein the copy request indicates one or more selected regions among the plural cloud regions.

22. A method comprising:
receiving a copy request indicating one of plural virtual machine templates to copy from a selected source region to a selected destination region among plural cloud regions;
reading the selected virtual machine template from a block storage device; and
transmitting the read virtual machine template to the selected destination region.

23. The method of claim 22 wherein the selected virtual machine template comprises one or more files compatible with a virtual machine definition and storage format.

24. The method of claim 22 wherein the copy request indicates one or more selected regions among the plural cloud regions.

25. A programmable computer system product comprising one or more data processing machines that execute instructions retrieved from a storage media, the instructions for:
receiving a copy request indicating one of plural virtual machine templates to copy from a selected source region to a selected destination region among plural cloud regions;
reading the selected virtual machine template from a block storage device; and
transmitting the read virtual machine template to the selected destination region.
